(19) United States
(12) Patent Application Publication
(10) Pub. No.: US 2023/0334819 A1
(43) Pub. Date: Oct. 19, 2023

(54) ILLUMINANT ESTIMATION METHOD AND APPARATUS FOR ELECTRONIC DEVICE

(71) Applicant: SAMSUNG ELECTRONICS CO., LTD., Suwon-si (KR)

(72) Inventors: Dongning HAO, Nanjing (CN); Guotao SHEN, Nanjing (CN); Xiaoli ZHU, Nanjing (CN); Qiang HUANG, Nanjing (CN); Longhai WU, Nanjing (CN); Jie CHEN, Nanjing (CN)

(73) Assignee: SAMSUNG ELECTRONICS CO., LTD., Suwon-si (KR)

(21) Appl. No.: 18/213,073

(22) Filed: Jun. 22, 2023

Related U.S. Application Data
(63) Continuation of application No. PCT/KR2021/019510, filed on Dec. 21, 2021.

(30) Foreign Application Priority Data
Dec. 22, 2020 (CN) 202011525309.4

(51) Int. Cl. G06V 10/60; G06V 10/75; G06T 7/70

(52) U.S. Cl. CPC G06V 10/60; G06V 10/757; G06T 7/70

(57) ABSTRACT

An illuminant estimation method, including acquiring two image frames, wherein a distance between the two image frames is greater than a predetermined distance; detecting shadows included in the two image frames, extracting pixel feature points corresponding to the shadows, determining point cloud information about the shadows, and distinguishing a point cloud of each shadow based on the point cloud information about the shadows; acquiring point cloud information about multiple objects, and distinguishing a point cloud of each object based on the point cloud information corresponding to the multiple objects; matching the point cloud of the each shadow and the point cloud of the each object in order to determine corresponding shadows associated with the multiple objects; and determining a position of an illuminant according to a positional relation between the multiple objects and the corresponding shadows.

### CROSS-REFERENCE TO RELATED APPLICATIONS

This application is a continuation of International Application No. PCT/KR2021/019510, filed on Dec. 21, 2021, in the Korean Intellectual Property Receiving Office, which is based on and claims priority to Chinese Patent Application No. 202011525309.4, filed on Dec. 22, 2020, in the China National Intellectual Property Administration, the disclosures of which are incorporated by reference herein in their entireties.

### BACKGROUND

### 1. Field

The present disclosure relates to image processing techniques, and more particularly to an illuminant estimation method and apparatus for an electronic device.

### 2. Description of Related Art

According to a first illuminant estimation technique, the overall brightness and color temperature of a virtual object may be calculated according to the brightness and color of an image. This technique may realize a high-quality environmental reflection effect, but it may not be able to predict the illuminant direction, so the direction of the shadow of the rendered virtual object may be incorrect. According to a second illuminant estimation technique, the environment mapping and illuminant direction may be predicted by machine learning. This technique may realize a high-quality environmental reflection effect, but the prediction accuracy of the illuminant direction may be low, especially in a scenario in which the illuminant is out of the visual range. So, these illuminant estimation techniques may not be able to fulfill accurate prediction of the position of illuminants out of the visual range.

According to some illuminant estimation techniques, the position of illuminants may be predicted through multi-sensor calibration and fusion and regional texture analysis of images, but this method has high requirements for the number and layout of devices. According to some illuminant estimation techniques, the illuminant position may be predicted through the coordination of mirror reflection spheres and ray tracing, but this method has high requirements for the features of reference objects.

### SUMMARY

Provided is an illuminant estimation method and apparatus for an electronic device to improve the prediction accuracy of the position of illuminants.

Additional aspects will be set forth in part in the description which follows and, in part, will be apparent from the description, or may be learned by practice of the presented embodiments.

In accordance with an aspect of the disclosure, an illuminant estimation method includes acquiring two image frames, wherein a distance between the two image frames is greater than a predetermined distance; detecting shadows included in the two image frames, extracting pixel feature points corresponding to the shadows, determining point cloud information about the shadows, and distinguishing a point cloud of each shadow based on the point cloud information about the shadows; acquiring point cloud information about multiple objects, and distinguishing a point cloud of each object based on the point cloud information corresponding to the multiple objects; matching the point cloud of the each shadow and the point cloud of the each object in order to determine corresponding shadows associated with the multiple objects; and determining a position of an illuminant according to a positional relation between the multiple objects and the corresponding shadows.

The determining of the position of the illuminant may include: for the each object, emitting a ray from a point farthest from the each object from among all edge points of a corresponding shadow to a highest point of the each object; and determining an intersection of at least two rays or an intersection of one ray and an illuminant direction predicted by an illumination estimation model as the position of the illuminant.

The detecting of the shadows included in the two image frames may include: converting the two image frames into gray images; and obtaining shadows included in the gray images.

The determining of the point cloud information about the shadows may include: mapping the pixel feature points corresponding to the shadows back to the two image frames, and representing each of the pixel feature points with a unique descriptor; and for the two image frames, determining a mapping relation of the pixel feature points in the two image frames by matching a descriptor, obtaining positions of the pixel feature points corresponding to the shadows in a three-dimensional (3D) space based on spatial mapping, and using the positions as the point cloud information about the shadows.

The obtaining of the positions of the pixel feature points may include: determining the positions of the pixel feature points by triangulation according to a first pose and a second pose of an acquisition device for acquiring the two image frames, and first pixel coordinates and second pixel coordinates of the pixel feature points.

The distinguishing of the point cloud of the each object may include: classifying point clouds belonging to a same object, from among all point clouds, to one category by clustering, and classifying point clouds belonging to different objects to different categories.

The determining of the corresponding shadows may include: determining the corresponding shadows based on a distance between the point cloud of the each shadow and the point cloud of the each object.

In accordance with an aspect of the disclosure, an illuminant estimation apparatus includes at least one processor configured to implement: an image acquisition unit configured to acquire two image frames, wherein a distance between the two image frames is greater than a set distance; a shadow detection unit configured to detect shadows included in the two image frames, extract pixel feature points corresponding to the shadows, determine point cloud information about the shadows, and distinguish a point cloud of each shadow based on the point cloud information about the shadows; an object distinguishing unit configured to acquire point cloud information about multiple objects and distinguish a point cloud of each object based on the point cloud information corresponding to the multiple objects; a shadow matching unit configured to match the point cloud of the each shadow and the point cloud of the each object in order to determine corresponding shadows associated with the multiple objects; and an illuminant estimation unit configured to determine a position of an illuminant according to a positional relation between the multiple objects and the corresponding shadows.

The illuminant estimation unit may be further configured to determine the position of the illuminant by: for the each object, emitting a ray from a point, farthest from the each object from among all edge points of a corresponding shadow to a highest point of the object; and determining an intersection of at least two rays or an intersection of one ray and an illuminant direction predicted by an illumination estimation model as the position of the illuminant.

The shadow detection unit may be further configured to detect the shadows of the two image frames by: converting the two image frames into gray images, and obtaining shadows included in the gray images.

The shadow detection unit may be further configured to determine the point cloud information about the shadows by: mapping the pixel feature points corresponding to the shadows back to the two image frames, and representing each of the pixel feature points with a unique descriptor; and for the two image frames, determining a mapping relation of the pixel feature points of the shadows in the two image frames by matching a descriptor, obtaining positions of the pixel feature points corresponding to the shadows in a three-dimensional (3D) space based on spatial mapping, and using the positions as the point cloud information about the shadows.

The shadow detection unit may be further configured to obtain the positions of the pixel feature points by: determining the positions of the pixel feature points by triangulation according to a first pose and a second pose of an acquisition device for acquiring the two image frames, and first pixel coordinates and second pixel coordinates of the pixel feature points.

The object distinguishing unit may be further configured to distinguish the point cloud of the each object by: classifying point clouds belonging to a same object, from among all point clouds, to one category by clustering, and classifying point clouds belonging to different objects to different categories.

The shadow matching unit may be further configured to determine the corresponding shadows by: determining the corresponding shadows based on a distance between the point cloud of the each shadow and the point cloud of the each object.

In accordance with an aspect of the disclosure, a non-transitory computer-readable storage medium configured to store instructions which, when executed by at least one processor, cause the at least one processor to: acquiring two image frames, wherein a distance between the two image frames is greater than a predetermined distance; detecting shadows included in the two image frames, extracting pixel feature points corresponding to the shadows, determining point cloud information about the shadows, and distinguishing a point cloud of each shadow based on the point cloud information about the shadows; acquiring point cloud information about multiple objects, and distinguishing a point cloud of each object based on the point cloud information corresponding to the multiple objects; matching the point cloud of the each shadow and the point cloud of the each object in order to determine corresponding shadows associated with the multiple objects; and determining a position of an illuminant according to a positional relation between the multiple objects and the corresponding shadows.

### BRIEF DESCRIPTION OF THE DRAWINGS

FIG. 1 illustrates effect pictures of a first illuminant estimation method, according to an embodiment;

FIG. 2 illustrates effect pictures of a second illuminant estimation method, according to an embodiment;

FIG. 3 is a basic flow diagram of an illuminant estimation method, according to an embodiment;

FIG. 4 is a schematic diagram of shadows in gray images, according to an embodiment;

FIG. 5 is a schematic diagram of the mapping relation of pixel feature points of the shadows, according to an embodiment;

FIG. 6 is a schematic diagram of point cloud information of the determined shadows, according to an embodiment;

FIG. 7 is a schematic diagram of distinguishing different objects by clustering, according to an embodiment;

FIG. 8 is a schematic diagram of determined objects and corresponding shadows, according to an embodiment;

FIG. 9 is a schematic diagram for determining the position and direction of an illuminant by means of at least two rays, according to an embodiment;

FIG. 10 is a schematic diagram for determining the position and direction of an illuminant based on one ray and an illumination estimation model, according to an embodiment;

FIG. 11 is a basic structural diagram of an illuminant estimation apparatus, according to an embodiment.

### DETAILED DESCRIPTION

Embodiments are explained in further detail below in conjunction with the accompanying drawings.

Embodiments may assist in solving problem of low prediction accuracy of the position of illuminants in specific scenarios. Accordingly, embodiments may relate to one or more of the following scenarios:
(1) A scenario in which there is only one illuminant or only one main illuminant indoors; (2) A scenario in which there are multiple actual objects (>=2) and the actual objects all have actual shadows; and (3) A scenario in which an illuminant is out of the visual field (or, the illuminant is within the visual field).

The applicant puts forward the above scenarios for the following reasons: (1) The actual application scenario of users may be a household indoor scenario with a few illuminants; (2) There may be multiple actual objects in the actual scenario, and the probability of no object is low; and (3) The users may not be able to stare at a light above when placing a virtual object on a plane such as a table top or the ground, that is, the illuminant is possibly out of the visual field.

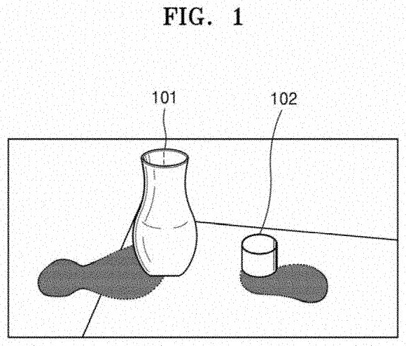

FIG. 1 illustrates effect pictures of a first illuminant estimation method.

Regarding the first illuminant estimation method, this method may realize a high-quality environmental reflection effect, but it may not be able to predict the illuminant direction, so the direction of the shadow of the rendered virtual object may be incorrect. For example, in FIG. 1 direction of the shadow of the bottle (101) is opposite direction of the shadow of the cup (102).

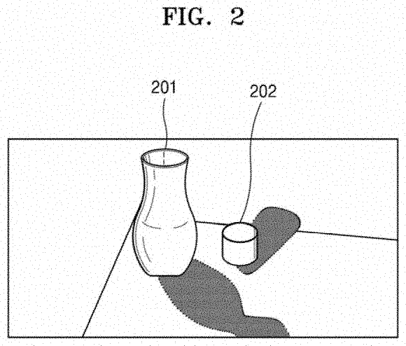

FIG. 2 illustrates effect pictures of a second illuminant estimation method.

Regarding the second illuminant estimation method, the environment mapping and illuminant direction may be predicted by machine learning. The prediction accuracy of the illuminant direction may be low, especially in a scenario in which the illuminant is out of the visual range. For example, in FIG. 2, direction of the shadow of the bottle (201) may be different direction of the shadow of the cup (202).

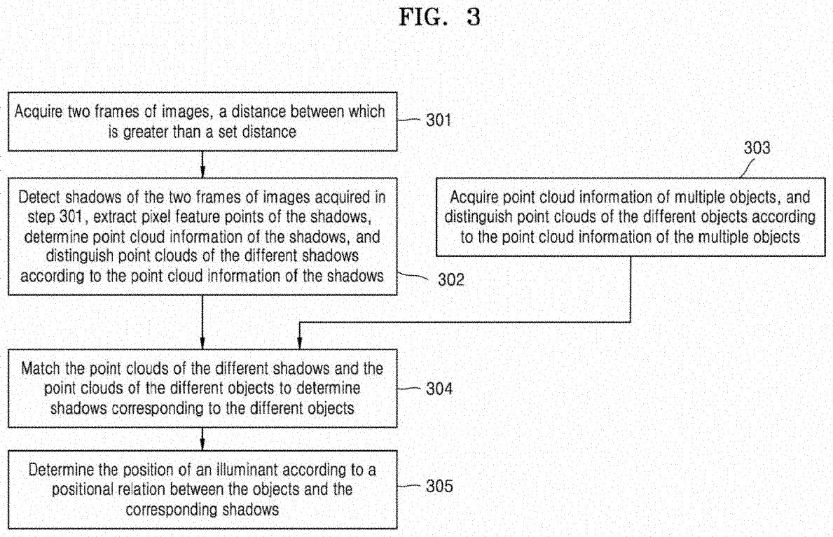

FIG. 3 is a basic flow diagram of an illuminant estimation method according to embodiments. Embodiments may predict the position of an illuminant based on shadows of objects. As shown in FIG. 3, the illuminant estimation method for an electronic device may include:

Operation 301: two frames of images, the distance between which is greater than a preset or predetermined distance, are acquired.

Two frames of images having a certain distance therebetween are acquired specifically as follows: images are taken at two different positions; or, two frames of video images having a certain distance therebetween are acquired in the moving process of the electronic device. The images acquired are typically colored images. In some embodiments, the “colored images” are not in a fixed format, and may be taken in real time by a device with a camera or may be two frames of images in a recorded video. Two frames of images, the distance between which is greater than a preset distance may represent two frames of images, the parallax between which is greater than a preset parallax.

Operation 302: shadows of the two frames of images acquired in Operation 301 are detected, pixel feature points of the shadows are extracted, point cloud information of the shadows is determined, and point clouds of the different shadows are distinguished according to the point cloud information of the multiple shadows.

The shadow detection unit (1120) is used for detecting shadows of the two frames of images acquired by the image acquisition unit (1110), extracting pixel feature points of the shadows, determining point cloud information of the shadows, and distinguishing point clouds of the different shadows according to the point cloud information of the shadows. Specifically, the shadow detection unit (1120) is used for detecting shadows of the two frames of images based on CNN.

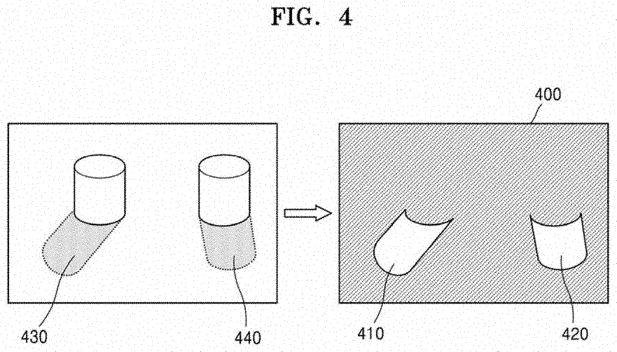

FIG. 4 is a schematic diagram of shadows in gray images according to embodiments. The shadows of the two frames of images may be detected as follows: each of the two frames of images is converted into a gray image, and shadows in the gray images are obtained by machine learning or graphics, wherein the white regions in the black-white images in FIG. 4 are shadow regions. For example, one of the two frames of images is converted into a gray image (400) in FIG. 4 that contains the white region (410) and white region (420). The white region (410) may correspond to the shadow (430), and the white region (420) may correspond to the shadow (440). Gray image may represent grayscale image in which the value of each pixel is a single sample representing only an amount of light that carries only intensity information. Grayscale images are distinct from one-bit bi-tonal black-and-white, Grayscale images have many shades of gray in between.

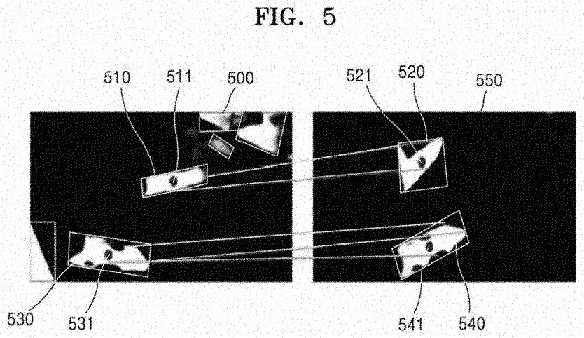

FIG. 5 is a schematic diagram of the mapping relation of pixel feature points of the shadows according to embodiments.

Specifically, after shadow detection, the pixel feature points of the shadows may be generated by computer graphics. When the point cloud information of the shadows is determined, the pixel feature points of the shadows may be mapped back to the two frames of images acquired in Operation 301, and each of the pixel feature points of the shadows is represented by a unique descriptor; for the two frames of images, the mapping relation of the pixel feature points of the shadows of the two frames of images is determined by matching the descriptors, as shown in FIG. 5. The edge pixel feature points and center pixel feature points of shadow in previous shadow map (500) may be edge (510), edge (530), center point (511) and center point (531). The edge pixel feature points and center pixel feature points of shadow in current shadow map (550) may be edge (520), edge (540), center point (521) and center point (541). Regarding matching the descriptors such as the pixel feature points of the shadows, edge (510), edge (530), center point (511) and center point (531) may correspond to edge (520), edge (540), center point (521) and center point (541).

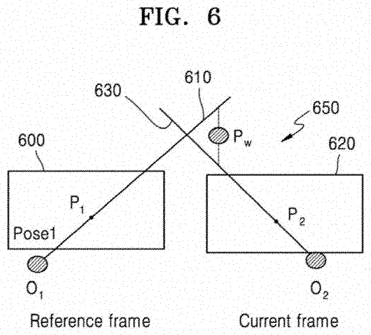

FIG. 6 is a schematic diagram of point cloud information of the determined shadows according to embodiments.

Next, the positions of the pixel feature points of the shadows in a 3D space are obtained based on spatial mapping and are used as the point cloud information of the shadows. Preferably, during spatial mapping, the positions of the pixel feature points of the shadows are determined by triangulation according to a Pose 1 and a Pose 2 of glasses for acquiring the two frames of images, and pixel coordinates p1 and p2 of corresponding points, as shown in FIG. 6. Taking into account the influence of noise, line (610) in reference frame (600) and line (630) in current frame (640) may not intersect. So the actual 3D coordinate may be calculated by least squares. By the least squares method, the position P_{w} (650) of the pixel feature point of the shadows may be acquired as the point cloud information of the corresponding shadow.

Operation 303: point cloud information of the multiple objects is obtained, and point clouds of the different objects are distinguished according to the point cloud information of the multiple objects.

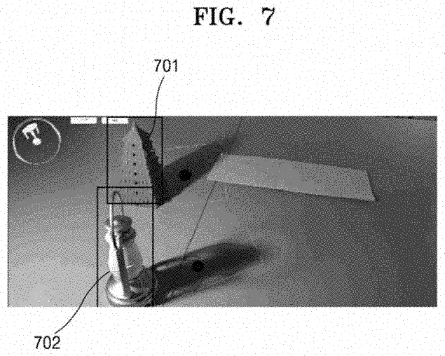

FIG. 7 is a schematic diagram of distinguishing different objects by clustering. In this step, the point cloud information of the objects in the scenario can be obtained by spatial positioning, and different objects corresponding to all the point clouds are classified by clustering, that is, all point clouds belonging to the same object are classified to one category by object distinguishing unit (1130), as shown in FIG. 7.

The point cloud information of the objects in the scenario can be obtained by spatial positioning. The point cloud information of the objects can be obtained by space localization. Different objects corresponding to all the point clouds are classified by clustering, for example using density-based spatial clustering of applications with noise (DBSCAN), that is, all point clouds belonging to the same object are classified to one category. For example, point cloud belonging to the object (701) and point cloud belonging to the object (702) are classified to the different category.

Operation 304: the point clouds of the different shadows and the point clouds of the different objects are matched to determine shadows corresponding to the different objects.

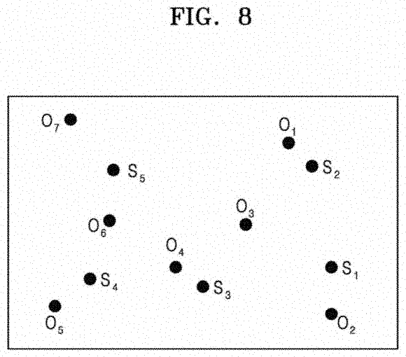

FIG. 8 is a schematic diagram of determined objects and corresponding shadows. As shown in FIG. 8, the shadow matching unit (1140) determining the shadows corresponding to the different objects by matching the point clouds of the different shadows and the point clouds of the different objects comprises: determining the shadows corresponding to the different objects based on distances between the point clouds of the different shadows and the point clouds of the different objects.

Methods of matching the objects and corresponding shadows are not limited. Considering the dynamic programming optimal pairing problem in 3D space, one of the method of matching the objects and corresponding shadows may correspond to Equation 1 below:

$$\begin{matrix}min ( sum ) \\ {p}_{i} ( {p}_{i} x , {p}_{i} y , {p}_{i} z )\end{matrix} = \begin{matrix}\text{?} sqrt ( {( {p}_{i} x - {s}_{i} x )}^{2} + {( {p}_{i} y - {s}_{i} y )}^{2} + {( {p}_{i} z - {s}_{i} z )}^{2} ) \\ {s}_{i} ( {s}_{i} x , {s}_{i} y , {s}_{i} z )\end{matrix} \qquad ( Eq . 1 )$$

$$\text{?} \text{indicates text missing or illegible when filed}$$

For each of the objects, a point at the bottom center of the object is selected as an object reference point Pᵢ; for each of the shadows, a central point Sᵢ of the shadow is selected as a shadow reference point and i may represent an index of the reference point or an index of the combination of the object reference point and the shadow reference point. There are M object reference points and N shadow reference points in the space point to form a combination. Ideally, number of object reference points M may equal to number of shadow reference points N.

Pi may represent an i-th object reference point, Pᵢx may represent value of x-axis of i-th reference point, Pᵢy may represent value of y-axis of i-th reference point and Pᵢz may represent value of z-axis of i-th reference point. Si may represent an i-th shadow reference point, sᵢx may represent value of x-axis of i-th shadow reference point, sᵢy may represent value of y-axis of i-th shadow reference point and sᵢz may represent value of z-axis of i-th shadow reference point.

Operation 305: the position of the illuminant is determined according to a positional relation between the objects and the corresponding shadows.
the position of the illuminant is determined according to a positional relation between the objects and the corresponding shadows by illuminant estimation unit (1150).

Specifically, for each of the objects, a ray is emitted from a point, farthest from the corresponding object, of all edge points of the shadow corresponding to the object to a highest point of the object. More specifically, the top center of each of the objects is selected as a reference point Oᵢ, a point S′_{i_j} in each shadow is set (i: the index of the object & shadow combination, j: an edge feature point of the shadow), the distances between Oᵢ and all S′_{i_j} are traversed, S′_{i_j} farthest from Oᵢ is searched out, and a ray from S′_{i_j} to Oᵢ is emitted.

The position of the illuminant is finally determined through the following two methods:

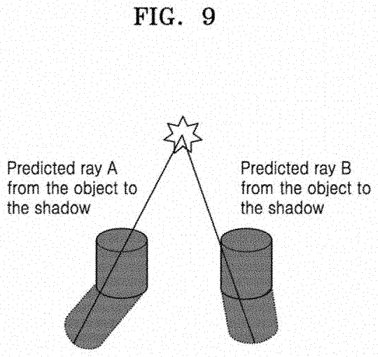

FIG. 9 is a schematic diagram for determining the position and direction of an illuminant by means of at least two rays. Regarding method 1, the position of the illuminant is calculated by triangulation by means of at least two rays. Specifically, at least two object and shadow combinations are determined, and the intersection of the rays of the two combinations is determined as the position of the illuminant, as shown in FIG. 9. For example, illuminant estimation unit (1150) may calculate the position of the intersection point of the two rays in the x-z plane. And, illuminant estimation unit may choose maximum value of the two rays in the y-axis direction as the y-value of the intersection point, which is the light source position.

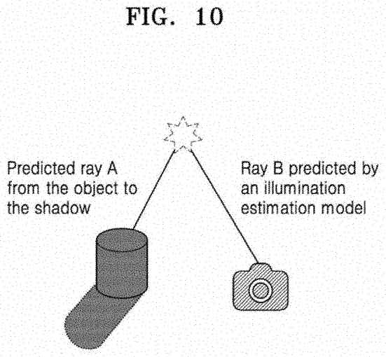

FIG. 10 is a schematic diagram for determining the position and direction of an illuminant by means of one ray and an illumination estimation model. Regarding method 2, the intersection of one ray and an illuminant direction predicted by an illumination estimation model is determined as the position of the illuminant, as shown in FIG. 10. Illuminant estimation unit (1150) may use the light estimation model to cooperate with the shadow detection to predict the light source position, that is, one light source direction through model prediction, another direction detected by the shadow. By multi-rays intersection, illuminant estimation unit (1150) may predict the position of the light source.

As described above, the illuminant estimation method based on the shadows of objects in an AR scenario detects the shadows of objects in the scenario and carries out illumination prediction on each frame of image according to the current pose of a camera in the AR scenario, so that an accurate environmental illumination direction and an accurate position prediction result are obtained. An example of a specific implementation of an illuminant estimation method according to embodiments has been described above. Embodiments may further provide an illuminant estimation apparatus (1100) which may be used to implement embodiments described above.

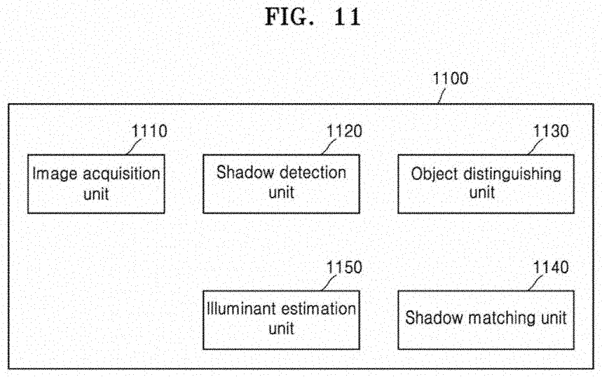

FIG. 11 is a structural diagram of the illuminant estimation apparatus (1100). As shown in FIG. 11, the apparatus comprises: an image acquisition unit (1110), a shadow detection unit (1120), an object distinguishing unit (1130), a shadow matching unit (1140) and an illuminant estimation unit (1150).

Wherein, the image acquisition unit (1110) is used for acquiring two frames of images, the distance between which is greater than a set distance. The shadow detection unit is used for detecting shadows of the two frames of images, extracting pixel feature points of the shadows, determining point cloud information of the shadows, and distinguishing point clouds of the different shadows according to the point cloud information of the shadows. The object distinguishing unit (1130) is used for acquiring point cloud information of the multiple objects and distinguishing point clouds of different objects according to the point cloud information of the multiple objects. The shadow matching unit (1140) is used for matching the point clouds of the different shadows and the point clouds of the different objects to determine shadows corresponding to the different objects. The illuminant estimation unit (1150) is used for emitting a ray from a point, farthest from the each object, of all edge points of the shadow corresponding to the object to a highest point of the object and determining an intersection of at least two rays or an intersection of one ray and an illuminant direction predicted by an illumination estimation model as the position of an illuminant.

The image acquisition unit (1110), the shadow detection unit (1120), the object distinguishing unit (1130), the shadow matching unit (1140) and the illuminant estimation unit (1150) may comprise independent processors and independent memories.

In another embodiment, apparatus (1100) may comprises processor and memory. The memory stores one or more instruction to be executed by the processor. And, the processor configured to execute the one or more instructions stored in the memory to acquire two frames of images, a distance between which is greater than a set distance; detect shadows of the two frames of images, extract pixel feature points of the shadows, determine point cloud information of the shadows, and distinguish point clouds of the different shadows according to the point cloud; acquire point cloud information of the multiple objects and distinguish point clouds of the different objects according to the point cloud information of the multiple objects information of the shadows; match the point clouds of the different shadows and the point clouds of the different objects to determine shadows corresponding to the different objects; determine a position of the illuminant according to a positional relation between the objects and the corresponding shadows.

The processor may include one or a plurality of processors, may be a general purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

In an embodiment, The memory stores one or more instruction to be executed by the processor for acquiring two frames of images, a distance between which is greater than a set distance; detecting shadows of the two frames of images, extracting pixel feature points of the shadows, determining point cloud information of the shadows, and distinguishing point clouds of the different shadows according to the point cloud information of the shadows; acquiring point cloud information of the multiple objects, and distinguishing point clouds of the different objects according to the point cloud information of the multiple objects; matching the point clouds of the different shadows and the point clouds of the different objects to determine shadows corresponding to the different objects; and determining a position of the illuminant according to a positional relation between the objects and the corresponding shadows. The memory may store storage part of the image acquisition unit (1110), storage part of the shadow detection unit (1120), storage part of the object distinguishing unit (1130), storage part of the shadow matching unit (1140) and storage part of the illuminant estimation unit (1150) in FIG. 11.

The memory storage elements may include magnetic hard discs, optical discs, floppy discs, flash memories, or forms of electrically programmable memories (EPROM) or electrically erasable and programmable (EEPROM) memories.

In addition, the memory may, in some examples, be considered a non-transitory storage medium. The term “non-transitory” may indicate that the storage medium is not embodied in a carrier wave or a propagated signal. However, the term “non-transitory” should not be interpreted that the memory is non-movable. In some examples, the memory can be configured to store larger amounts of information than the memory. In certain examples, a non-transitory storage medium may store data that can, over time, change (e.g., in Random Access Memory (RAM) or cache). The memory can be an internal storage or it can be an external storage unit of the illuminant estimation apparatus (1100), a cloud storage, or any other type of external storage.

The above embodiments are not intended to limit the disclosure. Any modifications, equivalent substitutions and improvements made based on the spirit and principle of the described embodiments should also fall within the scope of the disclosure.

What is claimed is:

1. An illuminant estimation method for an electronic device, the method comprising:
acquiring two image frames, wherein a distance between the two image frames is greater than a predetermined distance;
detecting shadows included in the two image frames, extracting pixel feature points corresponding to the shadows, determining point cloud information about the shadows, and distinguishing a point cloud of each shadow based on the point cloud information about the shadows;
acquiring point cloud information about multiple objects, and distinguishing a point cloud of each object based on the point cloud information corresponding to the multiple objects;
matching the point cloud of the each shadow and the point cloud of the each object in order to determine corresponding shadows associated with the multiple objects; and
determining a position of an illuminant according to a positional relation between the multiple objects and the corresponding shadows.

2. The method according to claim 1, wherein the determining of the position of the illuminant comprises:
for the each object, emitting a ray from a point farthest from the each object from among all edge points of a corresponding shadow to a highest point of the each object; and
determining an intersection of at least two rays or an intersection of one ray and an illuminant direction predicted by an illumination estimation model as the position of the illuminant.

3. The method according to claim 1, wherein the detecting of the shadows included in the two image frames comprises:
converting the two image frames into gray images; and
obtaining shadows included in the gray images.

4. The method according to claim 1, wherein the determining of the point cloud information about the shadows comprises:
mapping the pixel feature points corresponding to the shadows back to the two image frames, and representing each of the pixel feature points with a unique descriptor; and
for the two image frames, determining a mapping relation of the pixel feature points in the two image frames by matching a descriptor, obtaining positions of the pixel feature points corresponding to the shadows in a three-dimensional (3D) space based on spatial mapping, and using the positions as the point cloud information about the shadows.

5. The method according to claim 4, wherein the obtaining of the positions of the pixel feature points comprises:
determining the positions of the pixel feature points by triangulation according to a first pose and a second pose of an acquisition device for acquiring the two image frames, and first pixel coordinates and second pixel coordinates of the pixel feature points.

6. The method according to claim 1, wherein the distinguishing of the point cloud of the each object comprises:
classifying point clouds belonging to a same object, from among all point clouds, to one category by clustering, and classifying point clouds belonging to different objects to different categories.

7. The method according to claim 1, wherein the determining of the corresponding shadows comprises:
determining the corresponding shadows based on a distance between the point cloud of the each shadow and the point cloud of the each object.

8. An illuminant estimation apparatus, comprising:
at least one processor configured to implement:
an image acquisition unit configured to acquire two image frames, wherein a distance between the two image frames is greater than a set distance;
a shadow detection unit configured to detect shadows included in the two image frames, extract pixel feature points corresponding to the shadows, determine point cloud information about the shadows, and distinguish a point cloud of each shadow based on the point cloud information about the shadows;
an object distinguishing unit configured to acquire point cloud information about multiple objects and distinguish a point cloud of each object based on the point cloud information corresponding to the multiple objects;
a shadow matching unit configured to match the point cloud of the each shadow and the point cloud of the each object in order to determine corresponding shadows associated with the multiple objects; and
an illuminant estimation unit configured to determine a position of an illuminant according to a positional relation between the multiple objects and the corresponding shadows.

9. The apparatus according to claim 8, wherein the illuminant estimation unit is further configured to determine the position of the illuminant by: for the each object, emitting a ray from a point, farthest from the each object from among all edge points of a corresponding shadow to a highest point of the object; and determining an intersection of at least two rays or an intersection of one ray and an illuminant direction predicted by an illumination estimation model as the position of the illuminant.

10. The apparatus according to claim 8, wherein the shadow detection unit is further configured to detect the shadows of the two image frames by:
converting the two image frames into gray images, and obtaining shadows included in the gray images.

11. The apparatus according to claim 8, wherein the shadow detection unit is further configured to determine the point cloud information about the shadows by:
mapping the pixel feature points corresponding to the shadows back to the two image frames, and representing each of the pixel feature points with a unique descriptor; and
for the two image frames, determining a mapping relation of the pixel feature points of the shadows in the two image frames by matching a descriptor, obtaining positions of the pixel feature points corresponding to the shadows in a three-dimensional (3D) space based on spatial mapping, and using the positions as the point cloud information about the shadows.

12. The apparatus according to claim 11, wherein the shadow detection unit is further configured to obtain the positions of the pixel feature points by:
determining the positions of the pixel feature points by triangulation according to a first pose and a second pose of an acquisition device for acquiring the two image frames, and first pixel coordinates and second pixel coordinates of the pixel feature points.

13. The apparatus according to claim 8, wherein the object distinguishing unit is further configured to distinguish the point cloud of the each object by:
classifying point clouds belonging to a same object, from among all point clouds, to one category by clustering, and classifying point clouds belonging to different objects to different categories.

14. The apparatus according to claim 8, wherein the shadow matching unit is further configured to determine the corresponding shadows by:
determining the corresponding shadows based on a distance between the point cloud of the each shadow and the point cloud of the each object.

15. A non-transitory computer-readable storage medium configured to store instructions which, when executed by at least one processor, cause the at least one processor to:
acquire two image frames, wherein a distance between the two image frames is greater than a predetermined distance;
detect shadows included in the two image frames, extract pixel feature points corresponding to the shadows, determine point cloud information about the shadows, and distinguish a point cloud of each shadow based on the point cloud information about the shadows;
acquire point cloud information about multiple objects, and distinguish a point cloud of each object based on the point cloud information corresponding to the multiple objects;
match the point cloud of the each shadow and the point cloud of the each object in order to determine corresponding shadows associated with the multiple objects; and
determine a position of an illuminant according to a positional relation between the multiple objects and the corresponding shadows.
